(19) United States
(12) Patent Application Publication
(10) Pub. No.: US 2006/0218573 A1
(43) Pub. Date: Sep. 28, 2006

(54) Television program highlight tagging

(75) Inventor: Robert C. Proebstel, Beaverton, OR (US)

Correspondence Address: RICHARD C. CALDERWOOD, 2775 NW 126TH AVE, PORTLAND, OR, 97229-8381, US

(73) Assignee: Stexar Corp.

(21) Appl. No.: 11/073,097

(22) Filed: Mar. 4, 2005

(51) Int. Cl. H04H 9/00; H04N 7/16

(52) U.S. Cl. 725/14

(57) ABSTRACT

An improved audio-visual playback system which identifies and displays only high-interest segments of a program, according to peaks or thresholds of positive and negative user interaction events from a multitude of other users of the program. A personal video recorder which receives a history of positive user interaction events such as “thumbs up” approval events, jump backward events, and rewind events, and negative user interaction events such as “thumbs down” disapproval events, jump forward events, and fast forward events. If prior viewers gave high interest approval for a segment, either by affirmatively voting “thumbs up” or by rewatching the segment, the playback system plays that segment; otherwise the segment is skipped or muted, such that user can watch only the “highlights”.

### BACKGROUND OF THE INVENTION

1. Technical Field of the Invention

This invention relates generally to television program recording and viewing methodologies, and more specifically to a method for viewing only highlights of a program.

2. Background Art

FIG. 1 illustrates the television and internet networks. One or more television service providers (TV Service Providers 1 and 2) each provides television service such as via cable or satellite to a plurality of users (Users A and B, and Users C and D, respectively). Typically, each user will have a set-top box or other suitable interface mechanism located at his premises, for receiving and decoding the signals from his television service provider, and for providing conditional access, pay-per-view, and other such functionalities.

Each user has one or more display devices (TV Set) coupled to his set-top box(es), for displaying the television programs he watches. Typically, the user operates the display device and the set-top box with one or more remote control devices.

Optionally but increasingly more commonly, the user's set-top box and/or television set are coupled to the internet. Or, more specifically, they are coupled to an internet service provider which couples them to the internet. In some instances, the television service provider may also be the internet service provider. The television service provider may, themselves, have an internet service provider which couples them to the internet.

Presently, users are left to their own devices in selecting which programs to watch. They may get some guidance from generalized ratings provided by the television program content providers and/or the television service providers, but these are notoriously subjective and generalized.

More pointedly, these generalized ratings apply to entire programs.

What is desirable is a system which enables users to obtain more specific viewing guidance as to particular portions of a particular program.

### BRIEF DESCRIPTION OF THE DRAWINGS

FIG. 1 shows a large system including the internet, multiple internet service providers, multiple television service providers, and multiple user premises.

FIG. 2 shows a plot of various user interaction events over the course of a 120-minute television program.

FIG. 3 shows one embodiment of an improved television system according to one embodiment of this invention.

FIG. 4 shows one method of operation of the improved television system.

FIG. 5 shows another method of operation of the improved television system.

FIG. 6 shows one example of an enhanced on-screen electronic programming guide.

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

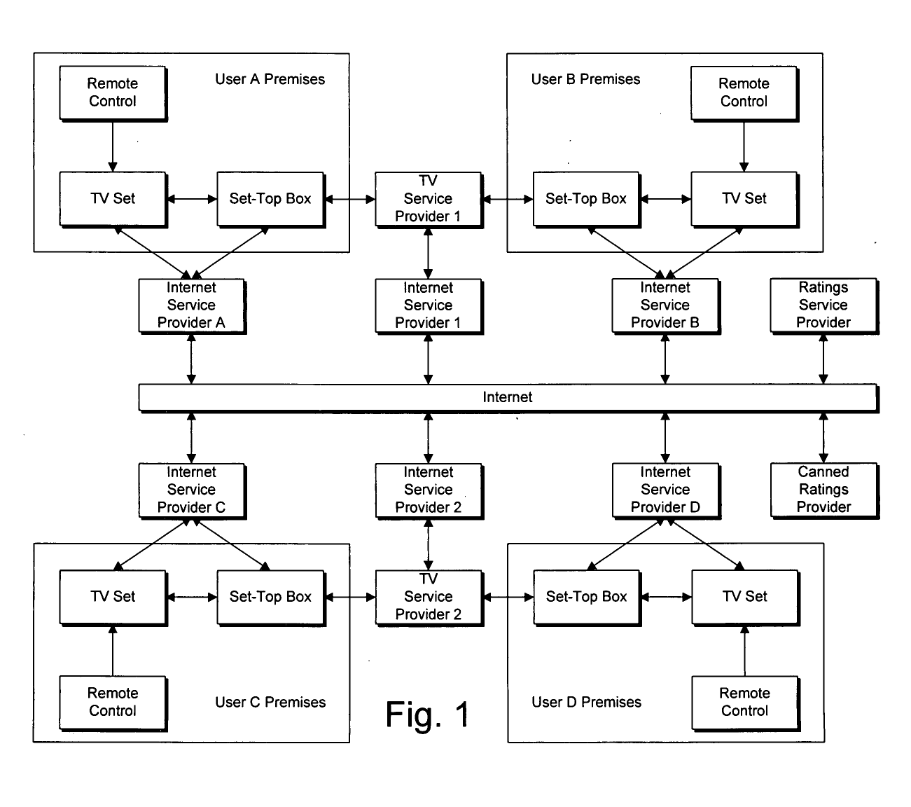

In addition to specific drawing figures to which the reader is referred, the reader should continue to make reference to FIG. 1 throughout this disclosure.

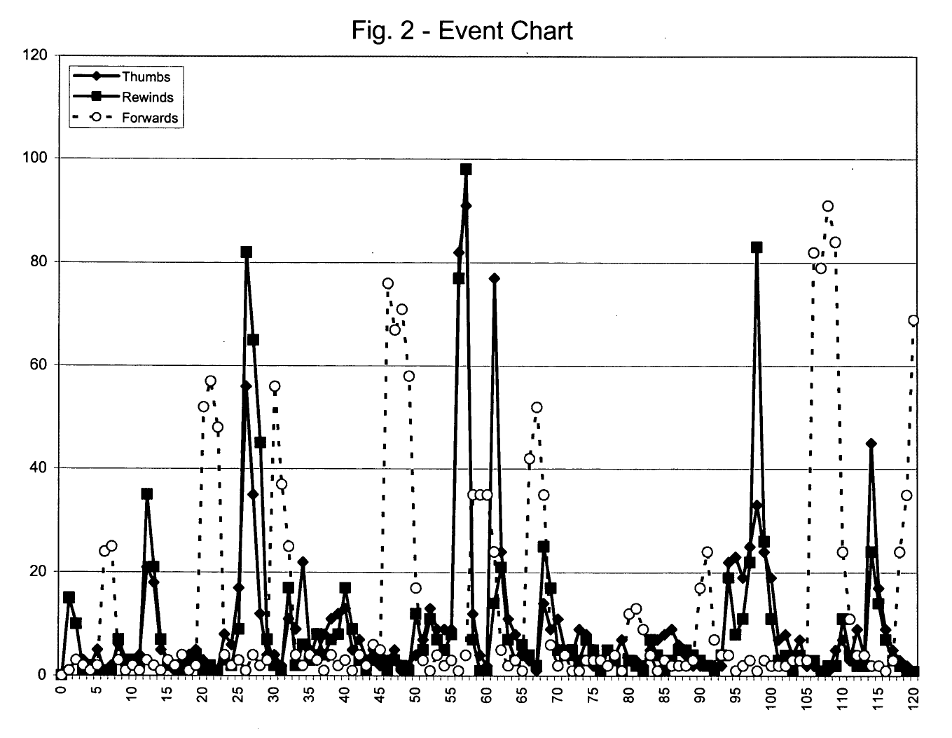

FIG. 2 illustrates a histogram or chart of user interaction events gathered over the course of an exemplary 120-minute television program. The program may be any sort of content, such as an episode of a television series, or a movie, or a sporting event, or any other particular content.

Three exemplary types of user interaction events are charted, but other types of events can certainly be used within the purview of this invention. The charted events include “thumbs”, “rewinds”, and “forwards”. Thumbs are the positive rating approval indicators which users of e.g. the Tivo system can enter on their remote control devices. Tivo uses these approval indicator events to gather data used in guessing which other programs a particular user is likely to enjoy watching. For example, if User A very often gives a “Thumbs Up” approval indicator during professional football and hockey games, the Tivo system may in the future send User A prior notifications of, or even cause his Tivo set-top box to automatically record, e.g. college football games or movies about hockey.

Existing systems, to applicant's knowledge, apply these approval indicators at a whole-program or even whole-genre level. Applicant's invention, by way of contrast, makes special use of the particular times at which such approval indicators are given by a multitude of viewers. For example, FIG. 2 illustrates approval indicators gathered from a multitude of users, who may be the subscribers of a single television service provider's system, or who may include all subscribers who have internet connected televisions or whose television service provider provides the approval indicator data to a Ratings Service Provider on the internet.

This group of users collectively gave a significant number of positive approval indicators around the 26 minute mark, an even bigger spike of them at around the 57 minute mark, again at the 62 minute mark, and somewhat smaller groupings or spikes at the 98 and 114 minute marks.

FIG. 2 also illustrates the numbers of “forward” and “rewind” events reported from the television sets or set-top boxes of this group of users, with spikes at the locations shown.

In one embodiment, the present invention makes special usage of such spikes. For example, the large groups of “thumbs” at 57 minutes, 62 minutes, etc. may be interpreted to identify especially interesting or good content at or around those time periods, which caused large numbers of users to register their approval. The users may be doing so for their own benefit, e.g. to tell their Tivo personal video recorder to notify them about similar future programs or to automatically record such programs, and/or the users may be doing so for the benefit of other users. The present invention thus in some measure changes the group dynamic of the television viewers, creating a cooperative community rather than a collection of disconnected individuals.

Some personal video recorders have the ability to “jump” ahead by a predetermined amount of time. For example, the Dish Network set-top box's remote control has a Skip button which causes playback to jump forward approximately 30 seconds. Often, this button is used for the purpose of skipping commercial advertisements. But it is also used for skipping boring or offensive portions of the actual television program.

Spikes of “jump forward” user events can be interpreted as identifying time periods which are likely to contain uninteresting, offensive, or advertisement content.

Spikes of “jump backward” user events can be interpreted as identifying time periods which are likely to contain highly interesting content. For example, many users will rewind or jump back to re-watch key plays in a football game, or to re-watch particularly funny moments in a movie.

However, because the user typically does not know exactly how many minutes of commercials to skip, very frequently a series of forward-forward-forward-etc. multiple skips will be followed immediately by one or more rewind skips. Often, or perhaps usually, the user skips forward one time too many, and has to slightly rewind to find the point at which the commercials ended and his television program resumed.

Spikes of rewind events which follow immediately after spikes of forward events may, in some instances, be nothing more than this and do not necessarily represent time periods of superb program content.

In addition to, or in lieu of, looking at the spikes, the system can utilize predetermined threshold values in deciding which segments of the program to display and which to skip. For example, the user may indicate that a thumb spike should be ignored unless it includes thumbs from at least 50,000 viewers. Or, the user may indicate that any portion of the program that caused at least 1,000 rewind events or rewind events from at least 17% of the total viewers should be viewed, even if it was not a local spike in the data.

In addition to jump-type rewind events, the user may also perform a conventional display-while-rewinding type of rewind event. And in addition to jump-type forward events, the user may also perform a conventional display-while-fast-forwarding.

As shown in FIG. 1, in some systems, it may be desirable to have a canned ratings provider to give preliminary rating or sample ratings events. In some embodiments, the canned ratings provider may be paid by the content providers to pre-view programs and provide sample thumbs and other events. In some such embodiments, these canned events are commingled with the actual user events, and serve to “seed” the pool. In other embodiments, the canned events are kept separate, enabling the end users to distinguish between canned events and actual user events, and to set thresholds etc. accordingly.

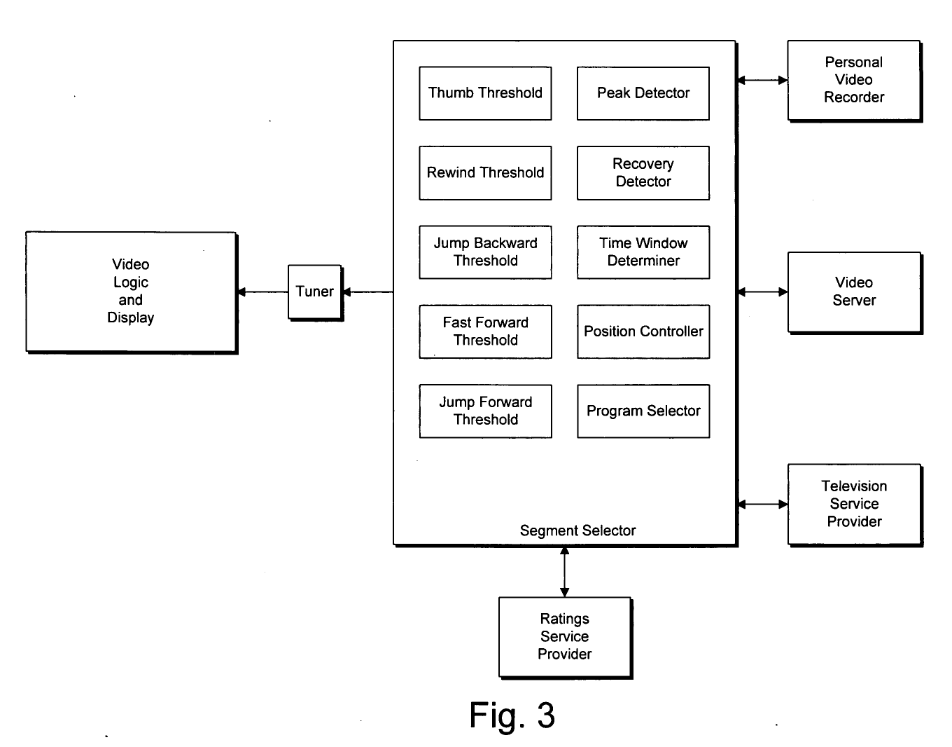

FIG. 3 illustrates an improved television system according to one embodiment of this invention. A television display device includes the actual display screen, and the video logic which drives the display picture. The video logic, or an intervening tuner, is driven by a Segment Selector which selects program segments for viewing, from video streams provided by one or more video sources such as a television service provider, a local video server, or a personal video recorder. The Segment Selector receives user interaction event statistics from a Ratings Service Provider.

The Segment Selector includes a Program Selector via which the user selects which program to watch, such as by selecting the program from an on-screen electronic program guide (EPG) from his television service provider, or from a list of programs which his PVR has recorded, or from a list of movies pre-installed on his video server.

A Position Controller controls the viewing flow through the selected program, determining which portions to show and which portions to skip and so forth.

A Thumb Threshold stores a threshold value for thumb events, below which a thumb value will not cause display of its time period of the program. A Rewind Threshold stores a threshold value for rewind events, below which a rewind value will not cause display of its time period of the program. A Jump Backward Threshold stores a threshold value for jump-back events. A Fast Forward Threshold stores a threshold value for fast-forward events. A Jump Forward Threshold stores a threshold value for jump or skip forward type events.

A Peak Detector identifies peaks of the various types of user interaction events being tracked. The Position Controller utilizes these identified peaks for selecting program segments to display, utilizing values stored in or generated by a Time Window Determiner to determine how much time before and how much time after the detected peak should be displayed. In one mode, the user can pre-program these before and after values, and they may be different for each of the various types of peaks detected.

In one embodiment, a Recovery Detector interacts with the Peak Detector to identify e.g. peaks of rewind or jump back events which, because they follow very closely after peaks of fast forward or jump forward events, are likely to be caused by users attempting to get to the point at which commercials ended and the actual program content resumed. In this embodiment, such peaks of recovery-oriented rewind and jump back events are suppressed from or at least identified for the Position Controller, as they do not likely represent highly interesting content.

The user should continue referring to FIGS. 1 and 3 now.

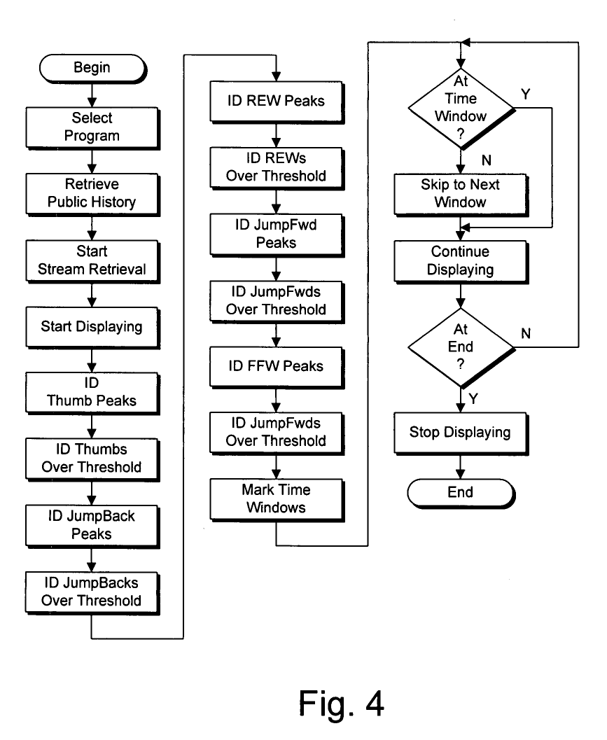

FIG. 4 illustrates one method of operation of the improved television viewing system of this invention. The method begins when the user selects a program for viewing. The Segment Selector retrieves the “public history” of user interaction events pertaining to this program, and the Position Controller starts retrieving the audio/video stream from the PVR, video server, television service provider, or the like, and the Position Controller may optionally cause the program to start displaying from its beginning point.

The Peak Detector identifies Thumb peaks, and further identifies program segments (particular periods of time) which are above the Thumb Threshold. The Peak Detector identifies jump-back peaks, and program segments which are above the Jump Backward Threshold. The Peak Detector identifies rewind peaks, and program segments which are above the Rewind Threshold. The Peak Detector identifies Jump Forward peaks, and program segments which are above the Jump Forward Threshold. The Peak Detector identifies Jump Forward peaks, and program segments which are above the Jump Forward Threshold.

The Time Window Determiner identifies time windows which should, according to the identified peaks and program time periods, be selected for viewing.

If the current program display position (time) is not within one of these marked time windows, the Position Controller skips forward to the beginning of the next marked time window. Program display continues, whether within the current window or at the start of the next window.

If the program reaches its end (either because the current display position has reached the end of the program stream, or because the final marked window has been displayed), the Position Controller stops causing display of the program and viewing ends. Otherwise, the Segement Selector continues monitoring for the next time window.

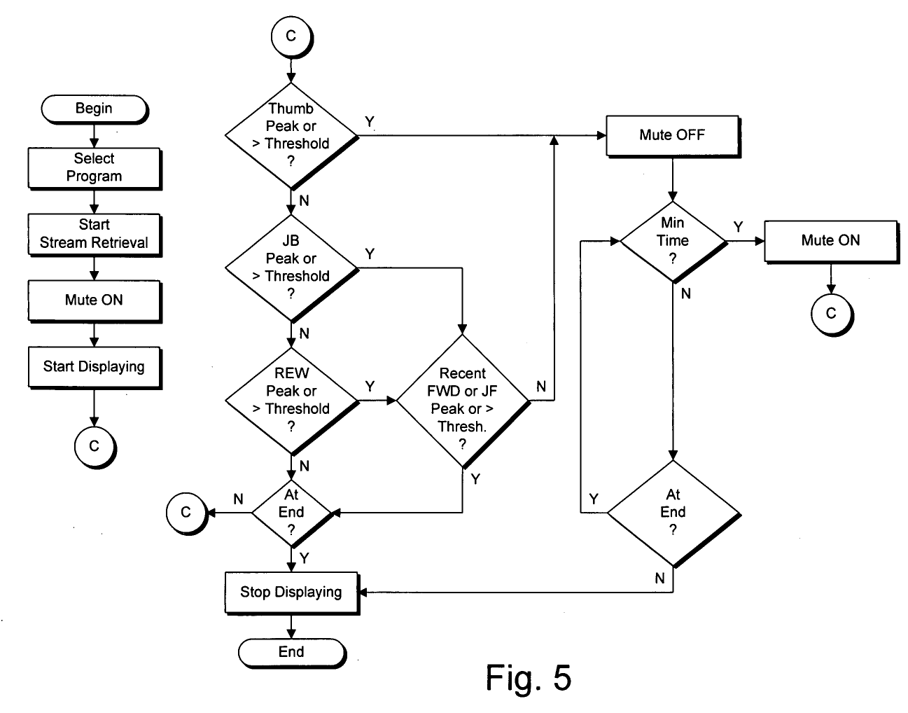

FIG. 5 illustrates another method of operating a television system according to this invention. This method is useful, for example, when a user event history is available but the audio/video program itself is available “on the fly” such as in the case of a conventional cable television broadcast, where the program is not pre-recorded on the user's PVR or otherwise available for skip-forward playback.

The method begins when the user selects a program for display, and the Position Controller starts retrieving the audio/video stream for that program. Because the audio/video program is being streamed in real time (whether or not from a live broadcast), the Segment Selector is unable to skip forward, and can only display the program as it is streamed. The Position Controller mutes the audio and/or video portions of the broadcast.

If the Peak Detector identifies that the current program “location” (time) is where a thumb peak occurred when other users previously viewed the program or a thumb peak has now occurred for the real time broadcast, or if the thumb value exceeds the Thumb Threshold, the Position Controller turns off the mute. After a predetermined minimum time has passed, the mute is again turned on, and the Segment Selector returns to monitoring for peaks etc. If the program reaches its end, display is stopped and the method ends.

If the current program position does not exceed the thumb threshold and does not have a thumb peak, the Peak Detector checks whether it has a peak of Jump Back events or is above the Jump Backward Threshold, or has a peak of Rewind events or is above the Rewind Threshold. If so, it then checks whether this is a “recovery” by checking for recent Forward or Jump Forward peaks and thresholds. If it is not a recovery, the mute is turned off for the minimum specified time period.

In one embodiment, the video portion continues to. display, the audio is muted, and closed captioning is turned on.

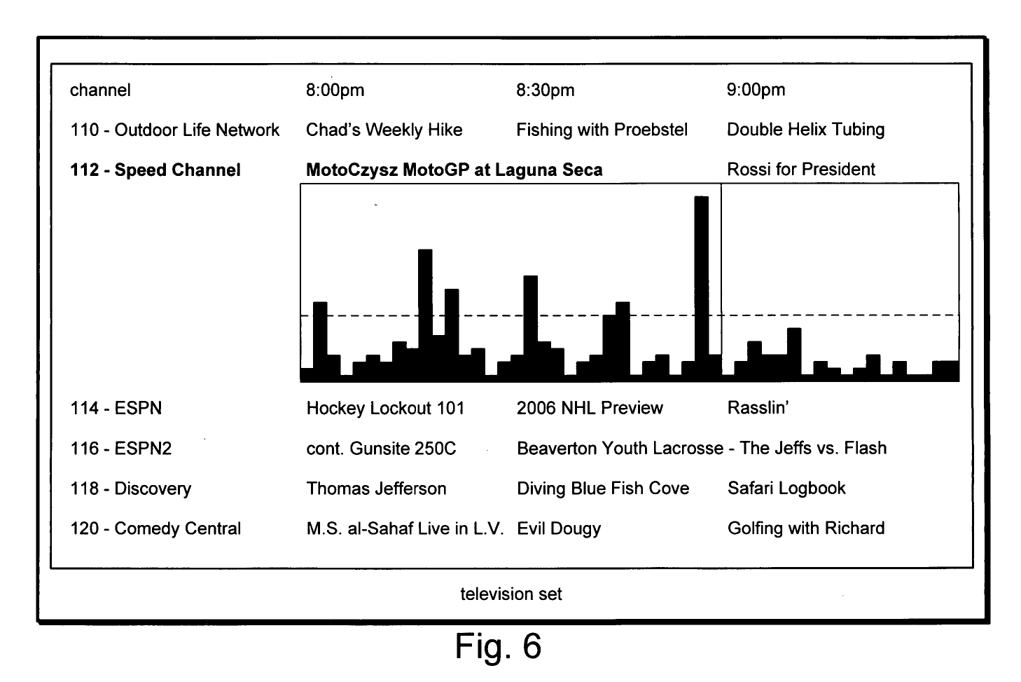

FIG. 6 illustrates one exemplary on-screen electronic programming guide displayed on a television set. The EPG indicates which programs are broadcast at a variety of time slots (the 8:00 pm, 8:30 pm, and 9:00 pm slots) on several channels (110, 112, 114, 116, 118, and 120). The user has navigated to 112 “Speed Channel” and to the program “MotoCzysz MotoGP at Laguna Seca” which is broadcast from 8:00 pm to 9:00 pm. The channel and program to which he has navigated are highlighted in any conventional manner (shown in bold text here).

The EPG display is enhanced with the insertion of the “thumbs” histogram for the selected program (and subsequent programming on the same channel, for convenience). The user's conventional thumb threshold is shown e.g. as a dashed line across the histogram, giving the user a quick visual indication of whether this program includes highlight segments which he should watch. The user may then choose to watch the program in its entirety, or to have the PVR record or display only the highlights, as indicated above.

In other embodiments, the histogram representation of a program's highlights may be overlayed onto the video display for the first few seconds after the user changes channels, enabling the user to quickly assess whether the new program is worth watching, or whether he should surf on past it, or perhaps whether there may be some interesting highlights later in the program which are worth returning to this channel later to view.

### CONCLUSION

While the invention has been described with respect to television programs, it may be used with any form of video and/or audio programming, such as terrestrial television broadcasts, satellite television broadcasts, cable television broadcasts, personal video recorders, video servers, terrestrial radio broadcasts, satellite radio broadcasts, internet video broadcasts, internet radio broadcasts, and so forth, whether pre-recorded, live, real time, or what have you.

The term “audio-visual” should be interpreted to mean including audio and/or video content. For example, a cable television broadcast, a DVD movie, a music CD, an electronic slide show of still photographs, and an MP3 audio track are all audio-visual programs.

The term “displaying” should be interpreted to include the displaying of visual images and/or the playing of audio sounds.

When one component is shown adjacent another component, it should not be interpreted to mean that there is absolutely nothing between the two components, only that they are in the order indicated or that they are directly or indirectly coupled or in communication with each other.

The various features illustrated in the figures may be combined in many ways, and should not be interpreted as though limited to the specific embodiments in which they were explained and shown.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A method of displaying an audio-visual program, the method comprising:
retrieving a history of user interaction events from a plurality of users of the audio-visual program;
displaying only those high-interest segments of the audio-visual program for which the history includes a peak of positive user interaction events and/or a number of positive user interaction events exceeding a predetermined threshold; and
preventing display of low-interest segments of the audio-visual program.

2. The method of claim 1 wherein:
the audio-visual program comprises a television program.

3. The method of claim 1 wherein:
the displaying of only the high-interest segments comprises playing the high-interest segments; and
the preventing of display of the low-interest segments comprises skipping forward beyond each low-interest segment to a next high-interest segment.

4. The method of claim 1 wherein:
the displaying of only the high-interest segments comprises playing the high-interest segments; and
the preventing of display of the low-interest segments comprises muting playback of the low-interest segments.

5. The method of claim 1 wherein:
the audio-visual program has been recorded and is available for skip forward playback; and
the history has been gathered from a previous playback of the audio-visual program for other users.

6. The method of claim 1 wherein:
the positive user interaction events comprise thumb events.

7. The method of claim 1 wherein:
the positive user interaction events comprise at least one of skip backward events and rewind events.

8. The method of claim 7 further comprising:
identifying recovery program segments whose skip backward events or rewind events identify them as high-interest segments but which follow closely after segments which have at least one of skip forward events and fast forward events identifying those as low-interest segments; and
treating the recovery program segments as low-interest segments.

9. The method of claim 1 further comprising:
identifying low-interest program segments according to negative user interaction events including at least one of fast forward events and skip forward events.

10. A method of displaying a television program which has been previously displayed for a plurality of other viewers, the television program including synchronized audio and video portions, the method comprising:
retrieving a history of user interaction events from the previous viewers;
responsive to the history, identifying high-interest program segments and low-interest program segments; and
for each respective program segment sequentially in the program,
if the respective program segment is a high-interest program segment, displaying the respective program segment, and
if the respective program segment is a low-interest program segment, muting at least one of the audio and video portions of the respective program segment.

11. The method of claim 10 wherein:
the user interaction events include positive user interaction events.

12. The method of claim 11 wherein:
the positive user interaction events include thumb events and at least one of jump back events and rewind events.

13. The method of claim 12 wherein:
the user interaction events further include negative user interaction events.

14. The method of claim 13 wherein:
the negative user interaction events include at least one of jump forward events and fast forward events.

15. The method of claim 10 wherein:
if the respective program segment is a low-interest program segment, the muting includes skipping the low-interest program segment to a next high-interest program segment.

16. The method of claim 10 wherein:
the muting includes muting the audio portion of the low-interest program segment.

17. The method of claim 16 wherein:
the muting further includes enabling closed captioning.

18. The method of claim 10 wherein:
the television program has been recorded for skip-forward playback; and
the muting comprises skipping forward to a next high-interest program segment.

19. A method of displaying electronic programming guide data on a television display, the method comprising:
displaying an identification of a channel;
displaying at least one time of day;
displaying, for that channel, a title of at least one program broadcast at the at least one time of day; and
displaying, for that program, an indication of highlight marker events associated with that program.

20. The method of claim 19 wherein:
the indication of highlight marker events comprises a graphical representation of the highlight marker events.

21. The method of claim 19 wherein:
the graphical representation comprises a histogram.

22. A method of displaying a television program on a display, the method comprising:
in response to a user changing from a previous channel to a new channel,
displaying a program currently broadcast on the new channel, and
temporarily displaying an indication of highlight marker events associated with that program.

23. The method of claim 2 wherein:
the indication of highlight marker events comprises a histogram plotting numbers of highlight marker events over at least a portion of the program.

24. A television system comprising:
a display screen;
video electronics coupled to drive the display screen; and
a segment selector coupled to provide a video signal to the video electronics, and coupled to receive a television program from a video source providing skip-forward playback, wherein the segment selector includes,
means for retrieving a history of user interaction events for the television program from a ratings service provider,
means, responsive to the history, for identifying high-interest program segments and low-interest program segments in the television program, and
a position controller for providing only the high-interest program segments to the video electronics.

25. The television system of claim 24 wherein the segment selector further includes:
a peak detector for identifying peaks of positive user interaction events in the history;
wherein the means for identifying high-interest program segments is responsive to the identified peaks.

26. The television system of claim 24 wherein the segment selector further includes:
means for maintaining a threshold value for a positive user interaction event type;
wherein the means for identifying high-interest program segments is responsive to the threshold value.

27. The television system of claim 26 wherein the segment selector further includes:
means for maintaining a threshold value for a negative user interaction event type;
wherein the means for identifying high-interest program segments is responsive to the threshold value for the negative interaction event type, to thereby identify low-interest program segments;
the position controller skipping the low-interest program segments.

28. The television system of claim 27 wherein the segment selector further includes:
means for identifying recovery segments in which seeming positive user interaction events do not identify high-interest program segments.
